(19) United States
(12) Patent Application Publication
(10) Pub. No.: US 2022/0300958 A1
(43) Pub. Date: Sep. 22, 2022

(54) CONTROL METHOD, DEVICE, AND RECORDING MEDIUM

(71) Applicant: Panasonic Intellectual Property Corporation of America, Torrance, CA (US)

(72) Inventors: Yuji UNAGAMI, Osaka (JP); Junji MICHIYAMA, Fukuoka (JP); Junichiro SOEDA, Nara (JP); Motoji OHMORI, Osaka (JP); Tetsuji FUCHIKAMI, Osaka (JP); Yuuki HIROSE, Osaka (JP); Naohisa NISHIDA, Osaka (JP); Masahiro TAGUCHI, Osaka (JP)

(21) Appl. No.: 17/836,349

(22) Filed: Jun. 9, 2022

Related U.S. Application Data
(63) Continuation of application No. PCT/JP2020/046402, filed on Dec. 11, 2020.
(60) Provisional application No. 62/950,522, filed on Dec. 19, 2019.

(51) Int. Cl. G06Q 20/38

(52) U.S. Cl. CPC G06Q 20/389

(57) ABSTRACT

A control method is executed by one device among devices included in a management system. Each of the devices includes a distributed ledger and stores: a parent smart contract including an automatic generation function of automatically generating a new smart contract; and a management function of selecting and managing one of child smart contracts generated by the devices. The control method includes: generating a first child smart contract; transmitting first transaction data including the generated first child smart contract to a different device and storing the first transaction data into the distributed ledger of the one device; receiving second transaction data including a second child smart contract generated by the different device and storing the second transaction data into the distributed ledger of the one device; and managing one child smart contract in association with the parent smart contract through execution of the management function.

### CROSS REFERENCE TO RELATED APPLICATIONS

This is a continuation application of PCT International Application No. PCT/JP2020/046402 filed on Dec. 11, 2020, designating the United States of America, which is based on and claims priority of U.S. Provisional Patent Application No. 62/950,522 filed on Dec. 19, 2019. The entire disclosures of the above-identified applications, including the specifications, drawings and claims are incorporated herein by reference in their entirety.

### FIELD

The present disclosure relates to a control method, a device, And a recording medium.

### BACKGROUND

A conventional smart contract technology automatically executes processing from confirmation of terms of a contract to implementation of the contract on a blockchain. For example, Patent Literature (PTL) 1 discloses a method of automatically executing a trade transaction procedure using a smart contract technology.

### CITATION LIST

### Patent Literature

PTL 1: WO 2019/003414

### SUMMARY

### Technical Problem

Unfortunately, the method disclosed in PTL 1 may cause a management system for managing a distributed ledger to operate inconsistently and thus function incorrectly.

In response to the above issue, it is an object of the present disclosure to provide a control method, a device, and a recording medium that are capable of enabling a management system for managing a distributed ledger to operate correctly.

### Solution to Problem

In accordance with an aspect of the present disclosure, a control method is executed by one device among a plurality of devices included in a management system. Each of the plurality of devices includes a distributed ledger that stores: a parent smart contract including an automatic generation function of automatically generating a new smart contract; and a management function of selecting and managing one of a plurality of child smart contracts generated through execution of the automatic generation function by the plurality of devices. The control method includes: generating a first child smart contract through execution of the automatic generation function; transmitting first transaction data including the first child smart contract generated to a different device among the plurality of devices and storing the first transaction data into the distributed ledger of the one device; receiving second transaction data including a second child smart contract generated through execution of the automatic generation function by the different device and storing the second transaction data into the distributed ledger of the one device; and managing one child smart contract that is one of the first child smart contract and the second child smart contract in association with the parent smart contract, through execution of the management function stored in the distributed ledger.

General or specific aspects of the present disclosure may be implemented to a system, a method, an integrated circuit, a computer program, a non-transitory computer-readable recording medium such as a Compact Disc-Read Only Memory (CD-ROM), or any given combination thereof.

### Advantageous Effects

The control method and so forth according to the present disclosure are capable of enabling a management system for managing a distributed ledger to operate correctly.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 illustrates an example of a configuration of a management system according to Embodiment,

FIG. 2 illustrates an example of a configuration of a server according to Embodiment.

FIG. 3 schematically illustrates first transaction data according to Embodiment.

FIG. 4 is a sequence diagram illustrating an example of a management process performed by the management system according to Embodiment.

FIG. 5 is a sequence diagram illustrating an example of the management process performed by the management system according to Embodiment.

FIG. 6 illustrates a first example of a setting process executed by a management function according to Embodiment.

FIG. 7 illustrates a first example of the management unction according to Embodiment.

FIG. 8 illustrates a second example of the setting process executed by the management function according to Embodiment.

FIG. 9 illustrates a second example of the management function according to Embodiment.

FIG. 10 illustrates a third example of the setting process executed by the management function according to Embodiment.

FIG. 11 illustrates a third example of the management function according to Embodiment.

FIG. 12 illustrates a fourth example of the setting process executed by the management function according to Embodiment,

FIG. 13 illustrates a fourth example of the management function according to Embodiment.

FIG. 14 illustrates a fifth example of the setting process executed by the management function according to Embodiment.

FIG. 15 illustrates a fifth example of the management function according to Embodiment,

FIG. 16 illustrates a sixth example of the setting process executed by the management function according to Embodiment.

FIG. 17 illustrates a sixth example of the management function according to Embodiment.

### DESCRIPTION OF EMBODIMENT

### Underlying Knowledge Forming Basis of the Present Disclosure

For example, a smart contract that executes a contract for a transaction may be implemented using the smart contract technology disclosed in PTL 1. In this case, a demand to automatically generate a smart contract that executes a new contract related to this transaction is to be expected.

However, the automatic generation of the new smart contract based on the smart contract using the conventional technology may cause the following issue.

A smart contract (a program) is stored in a distributed ledger held by each of a plurality of devices included in a management system. The management system automatically generates a new smart contract for each of the plurality of devices using the smart contract stored in the distributed ledger of this device. In this case, the new smart contract is automatically generated in each of the plurality of devices. Thus, as many identical smart contracts as the plurality of devices included in the management system are automatically generated. Moreover, all the automatically-generated smart contracts are shared by the distributed ledgers of the plurality of devices. This results in redundant storage of the same valid smart contracts by the plurality of devices. Thus, the same smart contracts are simultaneously executed by the plurality of devices, thereby causing the management system to operate inconsistently and thus function incorrectly.

In response to the above issue, the inventors found a control method, a device, and a recording medium described below.

In accordance with an aspect of the present disclosure, a control method is executed by one device among a plurality of devices included in a management system. Each of the plurality of devices includes a distributed ledger that stores: a parent smart contract including an automatic generation function of automatically generating a new smart contract; and a management function of selecting and managing one of a plurality of child smart contracts generated through execution of the automatic generation function by the plurality of devices. The control method includes: generating a first child smart contract through execution of the automatic generation function; transmitting first transaction data including the first child smart contract generated to a different device among the plurality of devices and storing the first transaction data into the distributed ledger of the one device; receiving second transaction data including a second child smart contract generated through execution of the automatic generation function by the different device and storing the second transaction data into the distributed ledger of the one device; and managing one child smart contract that is one of the first child smart contract and the second child smart contract in association with the parent smart contract, through execution of the management function stored in the distributed ledger.

In this case, the one child smart contract is selected from among the plurality of child smart contracts generated through the execution of the automatic generation function included in the parent smart contracts by the plurality of servers. Then, the one child smart contract selected is managed in association with the parent smart contract. This can prevent redundant storage of the same child smart contracts automatically generated based on the same parent smart contract. Thus, this can also prevent the execution of the same smart contracts by the plurality of devices, and thereby can prevent an inconsistent operation of the management system. As a result, the management system for managing the distributed ledgers can operate correctly.

It should be noted that it is possible that the management function is included in one of the parent smart contract and a management smart contract different from the parent smart contract,

the management smart contract is stored in the distributed ledger, the first transaction data includes execution information used for performing the management function on the first child smart contract, and the second transaction data includes execution information used for performing the management function on the second child smart contract.

In this case, whenever the first transaction data or the second transaction data is stored into the distributed ledger, the parent smart contract or the management smart contract can be executed, Thus, whenever the first transaction data or the second transaction data is stored into the distributed ledger, the management function can be automatically executed.

It should be noted that it is possible that the managing includes managing an n-th child smart contract (where n is a natural number) included in n-th transaction data that is one of the first transaction data and the second transaction data and that is stored n-th into the distributed ledger of the one device, as the one child smart contract in association with the parent smart contract.

Thus, the n-th generated child smart contract included in the n-th transaction data can be managed as the one child smart contract in association with the parent smart contract.

It should be noted that it is possible that the n is 1.

Thus, the first generated child smart contract included in the transaction data stored first into the distributed ledger can be managed as the one child smart contract in association with the parent smart contract.

It should be noted that it is possible that the n is a value that is randomly set.

Thus, the child smart contract included in the transaction data having a randomly-set ordinal number when stored into the distributed ledger can be managed as the one child smart contract in association with the parent smart contract. In this way, the ordinal number of the selected child smart contract is random and changeable. This can keep the child smart contract associated with the parent smart contract from being replaced by an altered child smart contract.

It should be noted that it is possible that the managing includes managing an identifier of the n-the child smart contract as an identifier of the one child smart contract so that the n-th child smart contract is managed as the one child smart contract in association with the parent smart contract.

This allows the one child smart contract to be easily associated with the parent smart contract.

It should be noted that it is possible that the managing includes not managing, as the one child smart contract, a child smart contract included in transaction data having an ordinal number other than the n-th when stored into the distributed ledger of the one device.

This allows only the n-th generated child smart contract to be associated with the parent smart contract.

It should be noted that it is possible that the managing includes disabling a child smart contract included in transaction data having an ordinal number other than the n-th when stored into the distributed ledger of the one device.

This allows only the n-th generated child smart contract to be associated with the parent smart contract. Moreover, this can also prevent a process of executing an invalid child smart contract, and thereby can reduce a processing load.

It should be noted that it is possible that the managing includes performing a destruction function, which destructs a smart contract, on a child smart contract included in transaction data having an ordinal number other than the n-th when stored into the distributed ledger of the one device.

This allows only the n-th generated child smart contract to be associated with the parent smart contract. Moreover, this can also prevent a process of executing the destructed child smart contract, and thereby can reduce a processing load.

In accordance with another aspect of the present disclosure, a device that is one device among a plurality of devices included in a management system and each including a distributed ledger includes: a processor; and a memory, wherein the distributed ledger stores: a parent smart contract including an automatic generation function of automatically generating a new smart contract; and a management function of selecting and managing one of a plurality of child smart contracts generated through execution of the automatic generation function by the plurality of devices, the processor, by using the memory: generates a first child smart contract through execution of the automatic generation function; transmits first transaction data including the first child smart contract generated to a different device among the plurality of devices and stores the first transaction data into the distributed ledger of the one device; receives second transaction data including a second child smart contract generated through execution of the automatic generation function by the different device and stores the second transaction data into the distributed ledger of the one device; and manages one child smart contract that is one of the first child smart contract and the second child smart contract in association with the parent smart contract, through execution of the management function stored in the distributed ledger.

In this case, the one child smart contract is selected from among the plurality of child smart contracts generated through the execution of the automatic generation function included in the parent smart contracts by the plurality of servers. Then, the one child smart contract selected is managed in association with the parent smart contract. This can prevent redundant storage of the same child smart contracts automatically generated based on the same parent smart contract. Thus, this can also prevent the execution of the same smart contracts by the plurality of devices, and thereby can prevent an inconsistent operation of the management system. As a result, the management system for managing the distributed ledgers can operate correctly.

In accordance with still another aspect of the present disclosure, a non-transitory computer-readable recording medium for use in a computer has a computer program recorded thereon for causing the computer to execute a control method to be executed by one device among a plurality of devices included in a management system and each including a distributed ledger that stores: a parent smart contract including an automatic generation function of automatically generating a new smart contract; and a management function of selecting and managing one of a plurality of child smart contracts generated through execution of the automatic generation function performed by the plurality of devices, the control method including: generating a first child smart contract through execution of the automatic generation function; transmitting first transaction data including the first child smart contract generated to a different device among the plurality of devices and storing the first transaction data into the distributed ledger of the one device; receiving second transaction data including a second child smart contract generated through execution of the automatic generation function by the different device and storing the second transaction data into the distributed ledger of the one device; and managing one child smart contract that is one of the first child smart contract and the second child smart contract in association with the parent smart contract, through execution of the management function stored in the distributed ledger.

In this case, the one child smart contract is selected from among the plurality of child smart contracts generated through the execution of the automatic generation function included in the parent smart contracts by the plurality of servers. Then, the one child smart contract selected is managed in association with the parent smart contract. This can prevent redundant storage of the same child smart contracts automatically generated based on the same parent smart contract. Thus, this can also prevent the execution of the same smart contracts by the plurality of devices, and thereby can prevent an inconsistent operation of the management system. As a result, the management system for managing the distributed ledgers can operate correctly.

Hereinafter, a certain exemplary embodiment will be described in detail with reference to the accompanying Drawings. The following embodiment is a specific example of the present disclosure. The numerical values, shapes, materials, elements, arrangement and connection configuration of the elements, steps, the order of the steps, etc., described in the following embodiment are merely examples, and are not intended to limit the present disclosure. Among elements in the following embodiment, those not described in any one of the independent claims indicating the broadest concept of the present disclosure are described as optional elements.

### EMBODIMENT

A system configuration according to the present disclosure is first described.

A management system according to the present disclosure includes a plurality of servers. A plurality of child smart contracts are automatically generated through execution of parent smart contracts by the plurality of servers. To manage the plurality of child smart contracts, the management system stores the plurality of child smart contracts into distributed ledgers. The following describes a configuration and so forth of the management system according to the present disclosure, with reference to the drawings.

### [Management System]

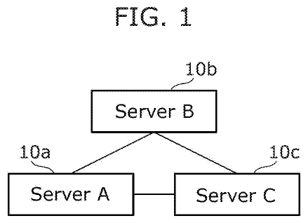

FIG. 1 illustrates an example of the configuration of the management system according to Embodiment.

As illustrated in FIG. 1, the management system according to Embodiment includes servers 10a to 10c, for example. All servers 10a to 10c may be connected to each other via a network. All servers 10a to 10c may be communicably connected directly to each other. Some of these servers may be connected to a network and some of the others may be communicably connected directly to each other. The network is the Internet or a mobile phone carrier network, for example. However, any communication line or network may be used. A set of servers 10a to 10c is an example of a plurality of devices included in the management system. The example of the plurality of devices included in the management system is not limited to servers 10a to 10c. The management system may include at least one terminal or only a plurality of terminals. The management system that manages the distributed ledgers storing blockchains may be of public, private, or consortium type.

In the following description, each of servers 10a to 10c may also be referred to as server 10, and servers 10a to 10c may also be referred to as servers A to C.

Hereinafter, server 10 is described.

### [Server 10]

Server 10 is an example of one device among the plurality of devices each holding a distributed ledger. Server 10 is managed by a business operator. The business operator may sign a contract with a user, for example. Under the contract, the user may be provided with goods or service in exchange for a predetermined counter value. Alternatively, the predetermined counter value may be paid to the user in exchange for work of the user. Moreover, the contract may be defined by gift, trade, exchange, loan for consumption, loan for use, lease, employment, contracting job, deposit, union, periodic payments for life, or settlement, for example.

Server 10 described here is one server 10 among servers 10a to 10c. Each server other than this one server 10 is referred to as different server 10. In the present embodiment, the number of different servers 10 is at least two. Thus, a server simply referred to as “different server 10” in the following may refer to a plurality of different servers 10. However, this is not intended to be limiting. The number of different servers 10 may be one.

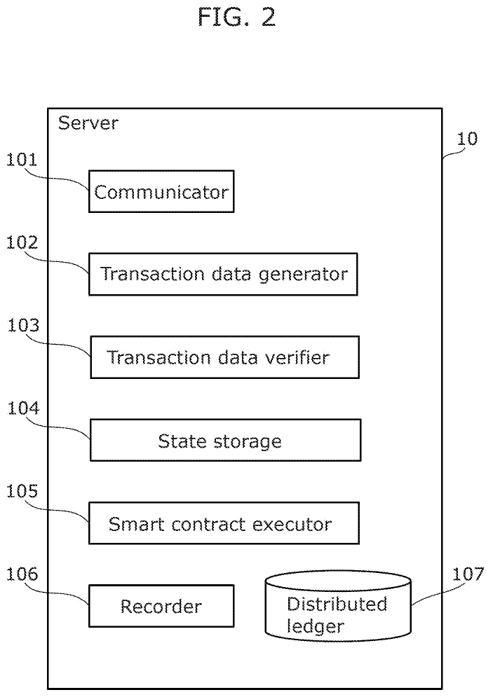

FIG. 2 illustrates an example of a configuration of a server according to Embodiment.

As illustrated in FIG. 2, server 10 includes communicator 101, transaction data generator 102, transaction data verifier 103, state storage 104, smart contract executor 105, recorder 106, and distributed ledger 107. Server 10 may be implemented by a processor that executes a predetermined program using a memory. These components are described as follows.

### [Communicator 101]

Communicator 101 transmits execution transaction data to different servers 10. The execution transaction data is stored into the distributed ledgers using a consensus algorithm implemented by servers 10a to 10c. Then, this execution transaction data causes servers 10a to 10c to execute respective parent smart contracts stored in the distributed ledgers of servers 10a to 10c. The execution of the parent smart contract by each of servers 10a to 10c allows a child smart contract to be generated as a new smart contract. Note that the execution of a parent smart contract generates a new smart contract. Note also that a child smart contract is a new smart contract generated by the execution of the parent smart contract.

Communicator 101 transmits first transaction data to different servers 10. The first transaction data includes a first child smart contract. The first child smart contract is generated through execution of an automatic generation function by server 10. Moreover, communicator 101 receives second transaction data from different server 10, The second transaction data includes a second child smart contract. The second child smart contract is generated through execution of the automatic generation function by different server 10.

Note that communicator 101 may exchange data other than the aforementioned transaction data with different servers 10. Note also that communicator 101 may exchange data with a device (a terminal) other than different servers 10.

In this way, communicator 101 communicates with different servers 10. Note that this communication may be achieved by Transport Layer Security (TLS), and that an encryption key for TLS communication may be held by communicator 101.

### [Transaction Data Generator 102]

Transaction data generator 102 generates execution transaction data. In the present embodiment, the execution transaction data includes execution information used by smart contract executor 105 to execute the parent smart contract stored in distributed ledger 107, This execution information includes an identifier that identifies the parent smart contract and a value (an argument) that is to be inputted to the parent smart contract. Here, the identifier that identifies the parent smart contract may be a storage location (an address) in distributed ledger 107 storing the parent smart contract. Alternatively, the identifier may be an identification number or a name of the parent smart contract.

Transaction data generator 102 may temporarily store the generated execution transaction data into state storage 104. Only one server 10 among servers 10a to 10c may include transaction data generator 102. Transaction data generator 102 transmits the generated execution transaction data to different servers 10 via communicator 101.

Moreover, transaction data generator 102 may generate first transaction data including a child smart contract generated by smart contract executor 105 described later. Transaction data generator 102 may temporarily store the generated first transaction data into state storage 104. Transaction data generator 102 transmits the generated first transaction data to different servers 10 via communicator 101.

Hereinafter, the first transaction data is described,

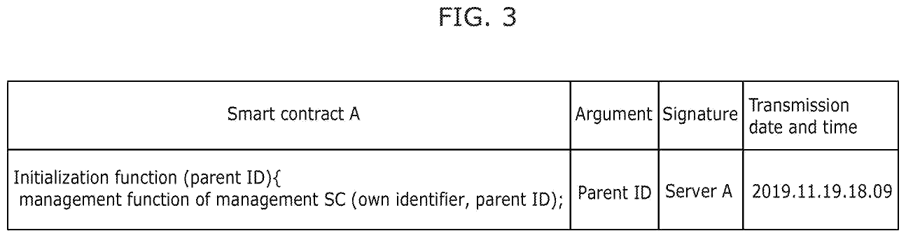

FIG. 3 schematically illustrates the first transaction data. The first transaction data includes: a first child smart contract; an identifier that is an argument for identifying the parent smart contract; a signature of server 10 that generates the first transaction data; and a transmission date and time of the first transaction data. FIG. 3 illustrates the first transaction data generated by server A as an example. “Initialization function” is firstly performed when smart contract A is executed. The initialization function includes a function of invoking and executing a management function included in a management smart contract. The initialization function includes an identifier of the management smart contract. The identifier of the management smart contract may be a storage location (an address) in distributed ledger 107 storing the management smart contract. Alternatively, the identifier may be an identification number or a name of the management smart contract. “Parent ID” indicates the identifier of the parent smart contract. “Smart contract A” indicates the child smart contract generated through the execution of the parent smart contract by server A. “Own identifier” indicates the identifier of the child smart contract generated through the execution of the parent smart contract by server A. To be more specific, this identifier may be a storage location (an address) in distributed ledger 107 storing the child smart contract. Alternatively, the identifier may be an identification number or a name of the child smart contract.

The first transaction data includes execution information used by smart contract executor 105 to execute the management smart contract. This execution information includes an identifier that identifies the management smart contract and a value (an argument) that is to be inputted to the management smart contract. Here, the identifier that identifies the management smart contract may be a storage location (an address) in distributed ledger 107 storing the management smart contract. Alternatively, the identifier may be an identification number or a name of the management smart contract.

The second transaction data generated by different server 10 has a structure similar to that of the first transaction data, and thus description on the structure of the second transaction data is omitted here.

### [Transaction Data Verifier 103]

When communicator 101 receives transaction data, transaction data verifier 103 verifies validity of this transaction data. For example, transaction data verifier 103 verifies whether the transaction data received by communicator 101 is affixed with an electronic signature that is correctly generated. Note that this verification may be skipped. Here, the transaction data received by communicator 101 is the second transaction data.

Moreover, when transaction data generator 102 generates transaction data, transaction data verifier 103 verifies validity of this transaction data. For example, transaction data verifier 103 verifies whether the transaction data generated by transaction data generator 102 is affixed with an electronic signature that is correctly generated. Note that this verification may be skipped. Here, the transaction data generated by transaction data generator 102 is the execution transaction data or the first transaction data.

Furthermore, transaction data verifier 103 executes a consensus algorithm with different servers 10 to agree on the validity of the transaction data.

Here, the consensus algorithm to be used here may be Practical Byzantine Fault Tolerance (PBFT) or any other known consensus algorithm. Examples of the known consensus algorithm include Proof of Work (PoW) and Proof of Stake (PoS). If PBFT is used as the consensus algorithm, transaction data verifier 103 receives, from each of different servers 10, a report indicating whether the verification of the transaction data is successful and then determines whether the number of reports exceeds a predetermined number. If the number of reports exceeds the predetermined number, transaction data verifier 103 may determine that the validity of the transaction data is verified by the consensus algorithm.

If verifying the validity of the transaction data, transaction data verifier 103 causes recorder 106 to record this transaction data.

In the present embodiment, transaction data verifier 103 verifies the validity of the execution transaction data, the validity of the first transaction data, and the validity of the second transaction data.

### [State Storage 104]

State storage 104 stores latest data of distributed ledger 107. The data stored in state storage 104 is changeable or deletable by a computer. State storage 104 may store transaction data before this transaction data is stored into distributed ledger 107. State storage 104 may store a smart contract invoked by the execution transaction data. State storage 104 may store a variable of the smart contract stored in distributed ledger 107. State storage 104 may store the transaction data generated by transaction data generator 102. To be more specific, state storage 104 may store the execution transaction data and the first transaction data. State storage 104 may store the transaction data received by communicator 101. To be more specific, state storage 104 may store the second transaction data.

State storage 104 may temporarily store these aforementioned pieces of data.

### [Smart Contract Executor 105]

Smart contract executor 105 executes the parent smart contract stored in distributed ledger 107 on the basis of first execution information included in the execution transaction data. Smart contract executor 105 invokes the parent smart contract stored in distributed ledger 107 on the basis of the identifier of the parent smart contract included in the first execution information. Then, smart contract executor 105 stores the invoked parent smart contract into state storage 104. The parent smart contract stored in distributed ledger 107 includes an automatic generation function of automatically generating a new smart contract (a child smart contract). Smart contract executor 105 executes the automatic generation function by executing the parent smart contract stored in state storage 104. As a result, smart contract executor 105 newly generates a child smart contract. Smart contract executor 105 may temporarily store the generated child smart contract into state storage 104.

Moreover, smart contract executor 105 executes the management smart contract stored in distributed ledger 107 on the basis of second execution information included in the first or second transaction data. Smart contract executor 105 invokes the management smart contract stored in distributed ledger 107 on the basis of the identifier of the management smart contract included in the second execution information. Then, smart contract executor 105 stores the invoked management smart contract into state storage 104. The management smart contract stored in distributed ledger 107 includes a management function of managing, as a valid child smart contract, one of a plurality of child smart contracts generated through the execution of the automatic generation function by the plurality of servers 10. Smart contract executor 105 executes the management function by executing the management smart contract stored in state storage 104. As a result, smart contract executor 105 selects one from among the plurality of child smart contracts, and manages the selected child smart contract in association with the parent smart contract. To be more specific, smart contract executor 105 stores the identifier of the parent smart contract into state storage 104 in association with the identifier of the selected child smart contract.

Note that the plurality of child smart contracts include: the first child smart contract automatically generated by server 10 on the basis of the parent smart contract; and the second child smart contract automatically generated by different server 10 on the basis of the parent smart contract. As described above, the second child smart contract is included in the second transaction data received by communicator 101 from different server 10.

### [Recorder 106]

Recorder 106 includes the transaction data, the validity of which is verified by transaction data verifier 103, into a block. Then, recorder 106 records the transaction data by storing this block into distributed ledger 107.

Note that recorder 106 may include distributed ledger 107.

### [Distributed Ledger 107]

Distributed ledger 107 stores the transaction data including the parent smart contract. Distributed ledger 107 stores the transaction data including the management smart contract that includes the management function. The management smart contract is different from the parent smart contract.

Note that the parent smart contract may include the management function in addition to the automatic generation function. In this case, distributed ledger 107 may not store the transaction data including the management smart contract, separately from the parent smart contract.

### [Operation of Management System etc.]

Next, an operation of the management system having the above configuration is described.

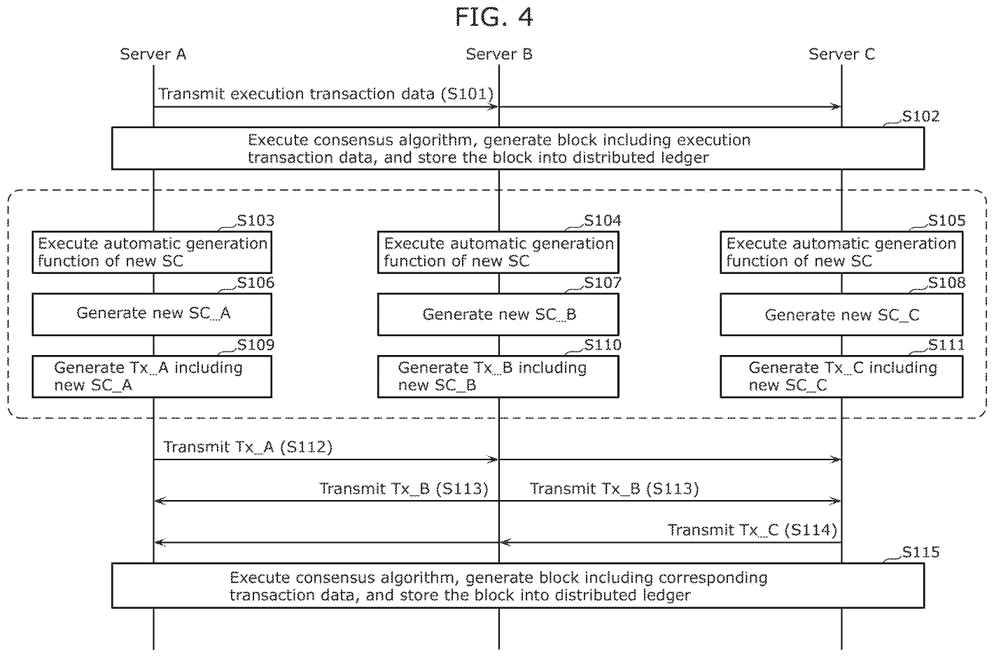

Each of FIG. 4 and FIG. 5 is a sequence diagram illustrating an example of a management process performed by the management system according to Embodiment. FIG. 5 illustrates a process continued from FIG. 4.

Firstly, server A generates execution transaction data and transmits the generated execution transaction data to servers B and C (S101).

Next, each of servers A, B, and C executes the consensus algorithm, generates a block including the execution transaction data, and stores the block into distributed ledger 107 (S102).

After executing the consensus algorithm for the execution transaction data, each of servers A, B, and C performs the automatic generation function of the parent smart contract (S103 to S105).

Next, each of servers A, B, and C generates a new smart contract. More specifically, as a result of performing the automatic generation function, server A generates new smart contract A as a child smart contract (S106). As a result of performing the automatic generation function, server B generates new smart contract B as a child smart contract (S107). As a result of performing the automatic generation function, server C generates new smart contract C as a child smart contract (S108). In FIG. 4, new smart contract A is denoted as new SC_A, new smart contract B is denoted as new SC_13, and new smart contract C is denoted as new SC_C.

Next, each of servers A, B, and C generates transaction data including the generated new smart contract. More specifically, server A generates transaction data A including new smart contract A (S109). Server B generates transaction data B including new smart contract B (S110). Server C generates transaction data C including new smart contract C (S111), In FIG. 4, transaction data A is denoted as Tx_A, transaction data B is denoted as Tx_B, and transaction data C is denoted as Tx_C.

Next, server A transmits transaction data A to servers B and C (S112). Server B transmits transaction data B to servers A and C (S113). Server C transmits transaction data C to servers A and B (S114).

Next, each of servers A, B, and C executes the consensus algorithm, generates a block including corresponding one of transaction data A, transaction data B, and transaction data C, and then stores the block into distributed ledger 107 (S115). Note that each of servers A, B, and C may execute the consensus algorithm for each transaction, generate a block including the corresponding transaction data, and then store the block into distributed ledger 107.

Following the execution of the consensus algorithm for transaction data A, each of servers A, B, and C performs the initialization function by executing the management smart contract (S116 to S118). More specifically, to perform the initialization function, each of servers A, B, and C executes the management smart contract identified by the identifier included in the second execution information included in transaction data A. In this way, each of servers A, B, and C performs the management function on new smart contract A included in transaction data A.

Next, each of servers A, B, and C sets a child smart contract to be associated with the parent smart contract by performing the management function (S119 to S121). This setting process is described in detail later.

Similarly, following the execution of the consensus algorithm for transaction data B, each of servers A, B, and C performs the initialization function by executing the management smart contract (S122 to S124), More specifically, to perform the initialization function, each of servers A, B, and C executes the management smart contract identified by the identifier included in the second execution information included in transaction data B. In this way, each of servers A, B, and C performs the management function on new smart contract B included in transaction data B.

Next, each of servers A, B, and C sets a child smart contract to be associated with the parent smart contract by performing the management function (S125 to S127). This setting process is described in detail later.

Similarly, following the execution of the consensus algorithm for transaction data C, each of servers A, B, and C performs the initialization function by executing the management smart contract (S128 to S130). More specifically, to perform the initialization function, each of servers A, B, and C executes the management smart contract identified by the identifier included in the second execution information included in transaction data C. In this way, each of servers A, B, and C performs the management function on new smart contract C included in transaction data C.

Next, each of servers A, B, and C sets a child smart contract to be associated with the parent smart contract by performing the management function (S131 to S133). This setting process is described in detail later.

Hereinafter, the setting process is described in detail for each of Steps S119 to S121, S125 to S127, and S131 to S133.

A first example of the setting process is first described.

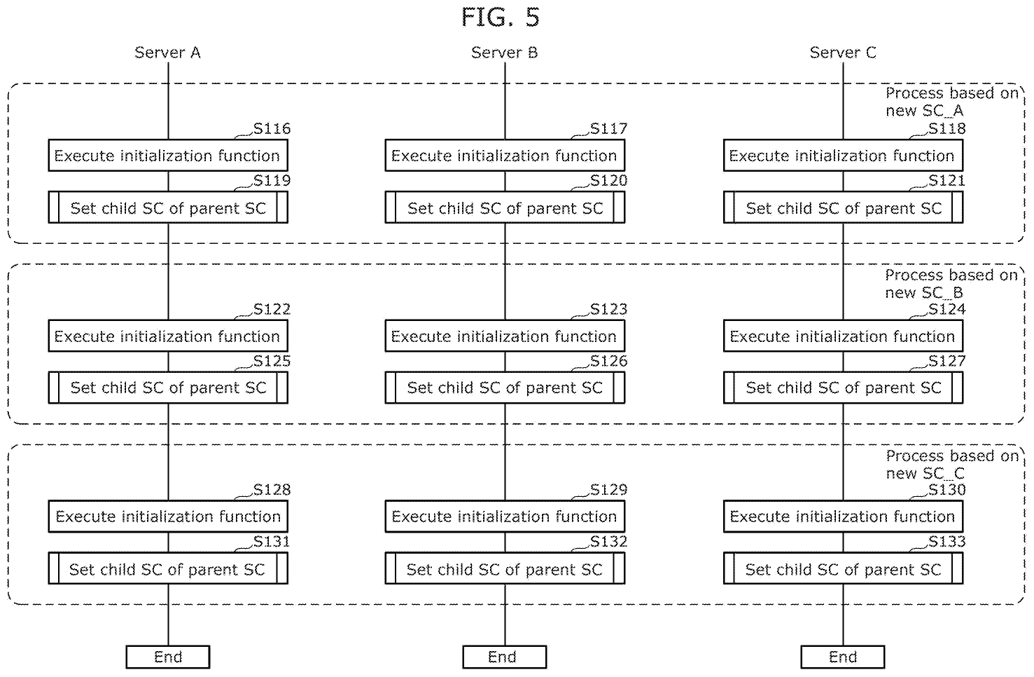

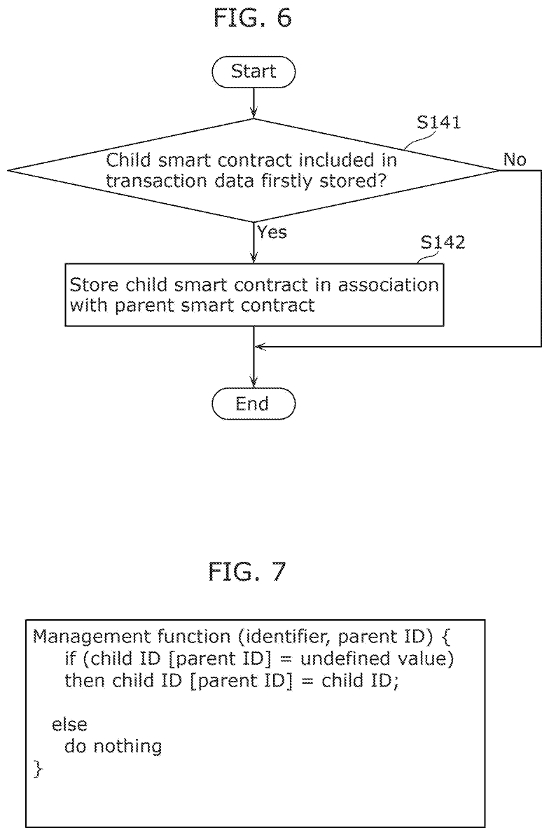

FIG. 6 illustrates the first example of the setting process executed by the management function according to Embodiment. FIG. 7 illustrates a first example of the management function according to Embodiment. Although the present embodiment describes that server A performs this process, servers 13 and C also perform this process. Note that the setting process executed by the management function may also be referred to as a management process.

As illustrated in FIG. 6, server A determines whether, among the plurality of child smart contracts generated based on the same parent smart contract, the smart contract included in the transaction data stored first into distributed ledger 107 is the new smart contract included in the transaction data that is a processing target (S141). To be more specific, on the basis of the second execution information included in the processing-target transaction data, server A invokes the management function stored in distributed ledger 107 and then performs the invoked management function using, as an argument, a parent ID included in the processing-target transaction data. Then, as illustrated in FIG. 7, server A determines whether a child ID associated with the parent ID (denoted as “child ID [parent ID]” in FIG. 7) is an undefined value. Here, information indicating an association between a parent ID and a child ID is stored in state storage 104. In an initial state, this association information associates the parent ID with an undefined value. The undefined value may be 0, null, or a predetermined fixed value. This undefined value may be any kind of information indicating that the parent ID is not associated with a child ID. If the child ID associated with the parent ID is an undefined value, server A determines that the smart contract included in the transaction data stored first into distributed ledger 107 is the new smart contract included in the processing-target transaction data.

Next, assume that server A determines that, among the plurality of child smart contracts generated based on the same parent smart contract, the smart contract included in the transaction data stored first into distributed ledger 107 is the new smart contract included in the processing-target transaction data (Yes in S141). In this case, server A stores the identifier of this new smart contract in association with the identifier of the parent smart contract (S142). This allows server A to manage this new smart contract in association with the parent smart contract. Server A updates (replaces) the undefined value associated with the parent ID to (with) the identifier of the new smart contract, in the association information stored in state storage 104, for example.

In contrast to this, assume that server A determines that, among the plurality of child smart contracts generated based on the same parent smart contract, the smart contract included in the transaction data stored first into distributed ledger 107 is not the new smart contract included in the processing-target transaction data (No in S141). In this case, server A ends the setting process. More specifically, server A ends the setting process without updating the association information stored in state storage 104. Thus, server A does not manage the smart contract included in the transaction data stored second or later into distributed ledger 107, in association with the parent smart contract.

In the setting process in Step S119 of FIG. 5, server A associates new smart contract A with the parent smart contract to firstly perform the initialization function on new smart contract A among new smart contracts A, B, and C, for example. As the association information already associates the parent smart contract with new smart contract A, server A maintains the current association information of new smart contracts B and C.

In the first example of the setting process, the first generated child smart contract included in the transaction data, which is one of the first transaction data and the second transaction data and stored first into distributed ledger 107 of server A, is managed as one child smart contract in association with the parent smart contract. This allows the first generated child smart contract included in the first stored transaction data to be managed as the one child smart contract in association with the parent smart contract.

Next, a second example of the setting process is described.

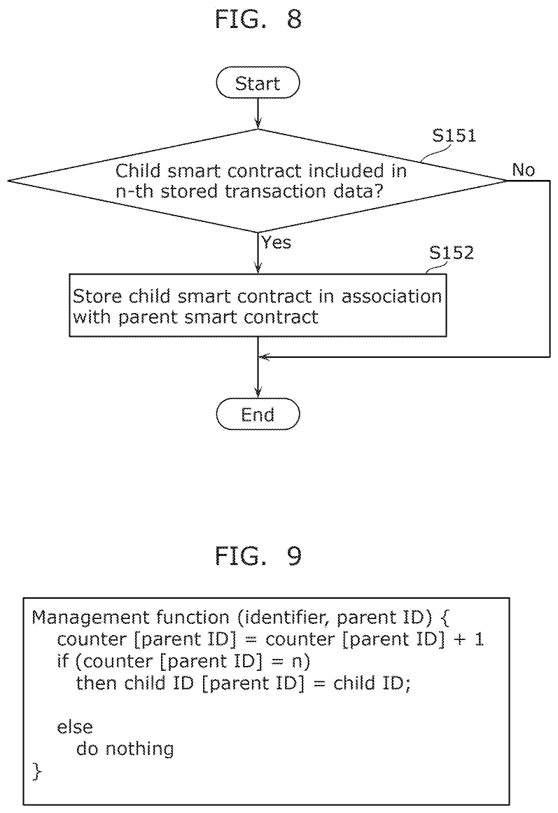

FIG. 8 illustrates the second example of the setting process executed by the management function according to Embodiment. FIG. 9 illustrates a second example of the management function according to Embodiment. Although the present embodiment describes that server A performs this process, servers 13 and C also perform this process.

As illustrated in FIG. 8, server A determines whether, among the plurality of child smart contracts generated based on the same parent smart contract, the smart contract included in n-th transaction data that is stored n-th into distributed ledger 107 is the new smart contract included in the processing-target transaction data (S151). Here, n is a natural number and may be a predetermined fixed value. To be more specific, on the basis of the second execution information included in the processing-target transaction data, server A invokes the management function stored in distributed ledger 107 and then performs the invoked management function using, as an argument, a parent ID included in the processing-target transaction data.

Note that n may be set at a different value for a different parent ID. Moreover, n may be a value randomly set for each parent ID. Thus, the child smart contract included in the transaction data having a randomly-set ordinal number when stored into the distributed ledger can be managed as the one child smart contract in association with the parent smart contract. In this way, the ordinal number of the selected child smart contract is random and changeable. This can keep the child smart contract associated with the parent smart contract from being replaced by an altered child smart contract.

Then, server A determines whether n is a value obtained by adding 1 to a counter associated with the parent ID (denoted as “counter [parent ID]” in FIG. 9). Note that the counter associated with the parent ID is stored in state storage 104, In an initial state, this counter is set at 0. Whenever executing Step S151, server A updates the counter to the value obtained by adding 1 to the counter associated with the parent ID.

Next, assume that server A determines that, among the plurality of child smart contracts generated based on the same parent smart contract, the smart contract included in the n-th transaction data stored into distributed ledger 107 is the new smart contract included in the processing-target transaction data (Yes in S151). In this case, server A stores the identifier of this new smart contract in association with the identifier of the parent smart contract (S152). This allows server A to manage this new smart contract in association with the parent smart contract. Server A stores the parent ID in association with the identifier of this new smart contract, for example.

In contrast to this, assume that server A determines that, among the plurality of child smart contracts generated based on the same parent smart contract, the smart contract included in the n-th transaction data stored into distributed ledger 107 is not the new smart contract included in the processing-target transaction data (No in S151). In this case, server A ends the setting process. More specifically, server A ends the setting process without updating the association information stored in state storage 104. Thus, server A does not manage the smart contract included in the transaction data having an ordinal number other than the n-th when stored into distributed ledger 107, in association with the parent smart contract.

For example, if n is 2, server A secondly performs the initialization function on new smart contract B stored second into distributed ledger 107 among new smart contracts A, B, and C, as illustrated in FIG. 5. In the setting process of Step S119, new smart contract A is not associated with the parent smart contract. In the setting process of Step S125, new smart contract B is associated with the parent smart contract. In the setting process of Step S131, new smart contract C is not associated with the parent smart contract.

In the second example of the setting process, the n-th child smart contract included in the n-th transaction data (where n is a natural number), which is one of the first transaction data and the second transaction data and stored n-th into distributed ledger 107 of server A, is managed as the one child smart contract in association with the parent smart contract. This allows the n-th child smart contract included in the n-th transaction data to be managed as the one child smart contract in association with the parent smart contract.

Moreover, in the first and second examples of the setting process, the child smart contract included in the transaction data stored second or later into distributed ledger 107 is not managed as the one child smart contract. This allows only the n-th smart contract to be associated with the parent smart contract.

Next, a third example of the setting process is described.

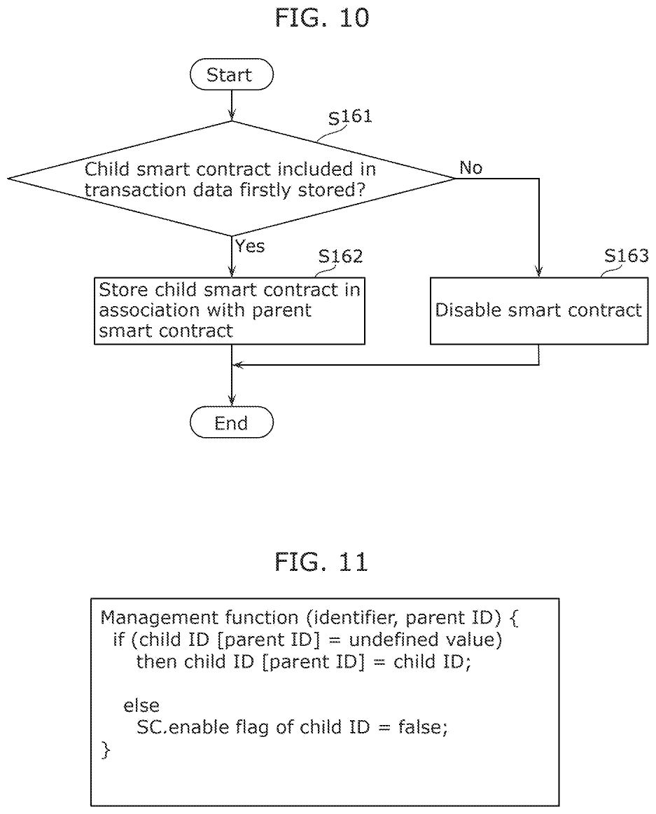

FIG. 10 illustrates the third example of the setting process executed by the management function. FIG. 11 illustrates a third example of the management function. Although the present embodiment describes that server A performs this process, servers B and C also perform this process.

As illustrated in FIG. 10, server A determines whether, among the plurality of child smart contracts generated based on the same parent smart contract, the smart contract included in the transaction data stored first into distributed ledger 107 is the new smart contract included in the processing-target transaction data (S161). Step S161 is the same as Step S141 and thus the detailed description is omitted.

Next, assume that server A determines that, among the plurality of child smart contracts generated based on the same parent smart contract, the smart contract included in the transaction data stored first into distributed ledger 107 is the new smart contract included in the processing-target transaction data (Yes in S161). In this case, server A stores the identifier of this new smart contract in association with the identifier of the parent smart contract (S162). Step S162 is the same as Step S142 and thus the detailed description is omitted.

In contrast to this, assume that server A determines that, among the plurality of child smart contracts generated based on the same parent smart contract, the smart contract included in the transaction data stored first into distributed ledger 107 is not the new smart contract included in the processing-target transaction data (No in S161). In this case, server A disables the smart contract included in transaction data stored second or later into distributed ledger 107 (S163). For example, server A may disable the smart contract included in the transaction data stored second or later into distributed ledger 107 by attaching, to this smart contract, invalidity information indicating that this smart contract is invalid. The invalidity information may be represented by a flag indicating whether the smart contract is valid or invalid. More specifically, the invalidity information may be a flag set at a value indicating that the smart contract is invalid.

Note that server A may enable the smart contract included in the transaction data stored first into distributed ledger 107 by attaching, to this smart contract, validity information indicating that this smart contract is valid. The validity information may be represented by a flag indicating whether the smart contract is valid or invalid. More specifically, the validity information may be a flag set at a value indicating that the smart contract is valid.

In the setting process in Step S119 of FIG. 5, server A associates new smart contract A with the parent smart contract to firstly perform the initialization function on new smart contract A among new smart contracts A, B, and C, for example. Then, server A disables new smart contracts B and C.

In the third example of the setting process, the first generated child smart contract included in the transaction data, which is one of the first transaction data and the second transaction data and stored first into distributed ledger 107 of server A, is managed as the one child smart contract in association with the parent smart contract. This allows the first generated child smart contract included in the first stored transaction data to be managed as the one child smart contract in association with the parent smart contract.

In the third example of the setting process, the child smart contract included in the transaction data stored second or later into distributed ledger 107 of server A is disabled. This allows only the first generated child smart contract to be associated with the parent smart contract. This also prevents a process of executing an invalid smart contract and thereby reduces a processing load.

Next, a fourth example of the setting process is described.

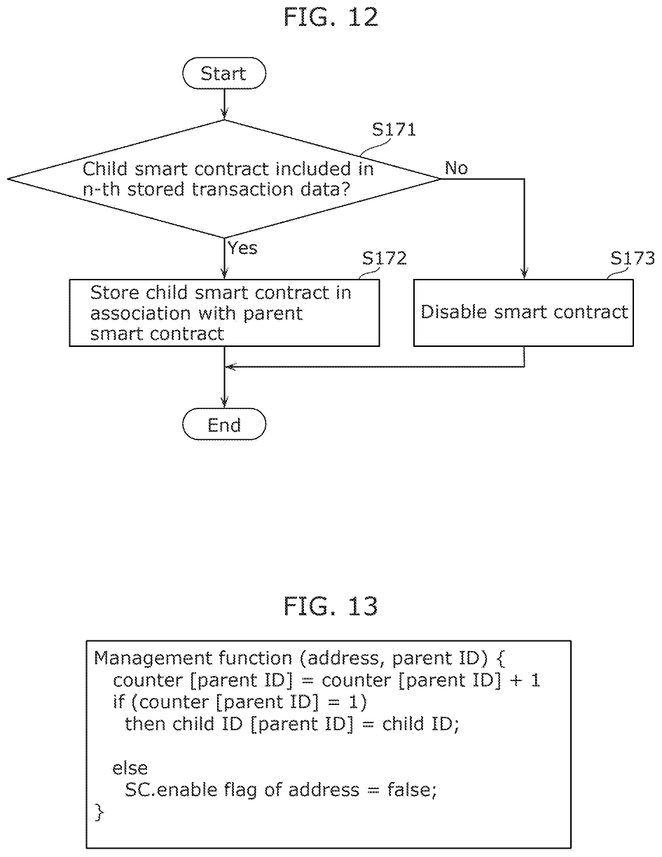

FIG. 12 illustrates the fourth example of the setting process executed by the management function. FIG. 13 illustrates a fourth example of the management function. Although the present embodiment describes that server A performs this process, servers B and C also perform this process.

As illustrated in FIG. 12, server A determines whether, among the plurality of child smart contracts generated based on the same parent smart contract, the smart contract included in n-th transaction data that is stored n-th into distributed ledger 107 is the new smart contract included in the processing-target transaction data (S171). Step S171 is the same as Step S151 and thus the detailed description is omitted.

Next, assume that server A determines that, among the plurality of child smart contracts generated based on the same parent smart contract, the smart contract included in the n-th transaction data stored into distributed ledger 107 is the new smart contract included in the processing-target transaction data (Yes in S171). In this case, server A stores the identifier of this new smart contract in association with the identifier of the parent smart contract (S172). Step S172 is the same as Step S152 and thus the detailed description is omitted.

In contrast to this, assume that server A determines that, among the plurality of child smart contracts generated based on the same parent smart contract, the smart contract included in the n-th transaction data stored into distributed ledger 107 is not the new smart contract included in the processing-target transaction data (No in S171). In this case, server A disables the smart contract included in transaction data having an ordinal number other than the n-th when stored into distributed ledger 107 (S173). Step S173 is the same as Step S163 and thus the detailed description is omitted.

For example, if n is 2, server A secondly performs the initialization function on new smart contract B stored second into distributed ledger 107 among new smart contracts A, B, and C, as illustrated in FIG. 5, In the setting process of Step S119, new smart contract A is disabled. In the setting process of Step S125, new smart contract B is associated with the parent smart contract. In the setting process of Step S131, new smart contract C is disabled.

In the fourth example of the setting process, the n-th child smart contract included in the n-th transaction data (where n is a natural number), which is one of the first transaction data and the second transaction data and stored n-th into distributed ledger 107 of server A, is managed as the one child smart contract in association with the parent smart contract. This allows the n-th child smart contract included in the n-th transaction data to be managed as the one child smart contract in association with the parent smart contract.

Moreover, in the fourth example of the setting process, the smart contract included in the transaction data having the ordinal number other than the n-th when stored into distributed ledger 107 is disabled. This allows only the n-th child smart contract to be associated with the parent smart contract. This also prevents a process of executing an invalid smart contract and thereby reduces a processing load.

Next, a fifth example of the setting process is described.

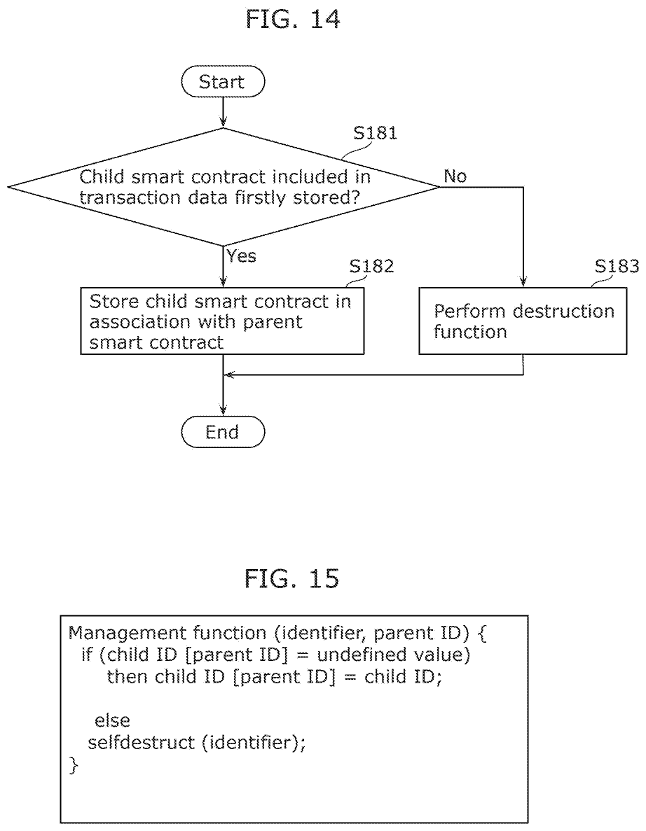

FIG. 14 illustrates the fifth example of the setting process executed by the management function. FIG. 15 illustrates a fifth example of the management function. Although the present embodiment describes that server A performs this process, servers B and C also perform this process.

As illustrated in FIG. 14, server A determines whether, among the plurality of child smart contracts generated based on the same parent smart contract, the smart contract included in the transaction data stored first into distributed ledger 107 is the new smart contract included in the processing-target transaction data (S181). Step S181 is the same as Step S141 and thus the detailed description is omitted.

Next, assume that server A determines that, among the plurality of child smart contracts generated based on the same parent smart contract, the smart contract included in the transaction data stored first into distributed ledger 107 is the new smart contract included in the processing-target transaction data (Yes in S181). In this case, server A stores the identifier of this new smart contract in association with the identifier of the parent smart contract (S182). Step S182 is the same as Step S142 and thus the detailed description is omitted.

In contrast to this, assume that server A determines that, among the plurality of child smart contracts generated based on the same parent smart contract, the smart contract included in the transaction data stored first into distributed ledger 107 is not the new smart contract included in the processing-target transaction data (No in S181). In this case, server A performs a destruction function on the smart contract included in transaction data stored second or later into distributed ledger 107 (S183). The destruction function is denoted as “selfdestruct” indicating the destruction function of the smart contract on Ethereum, for example. This function makes a target smart contract invalid on distributed ledger 107. For example, by performing the destruction function on a smart contract, server A can disable a block of a blockchain storing this smart contract.

In the setting process in Step S119 of FIG. 5, server A associates new smart contract A with the parent smart contract to firstly perform the initialization function on new smart contract A among new smart contracts A, B, and C, for example. Then, server A performs the destruction function on new smart contracts B and C.

In the fifth example of the setting process, the first generated child smart contract included in the transaction data, which is one of the first transaction data and the second transaction data and stored first into distributed ledger 107 of server A, is managed as the one child smart contract in association with the parent smart contract. This allows the first generated child smart contract included in the first stored transaction data to be managed as the one child smart contract in association with the parent smart contract.

Moreover, in the fifth example of the setting process, the destruction function, which destructs a smart contract, is performed on the child smart contract included in the transaction data stored second or later into distributed ledger 107 of server A. This allows only the second-or-later generated smart contract to be associated with the parent smart contract. This also prevents a process of executing the destructed child smart contract and thereby reduces a processing load.

Next, a sixth example of the setting process is described.

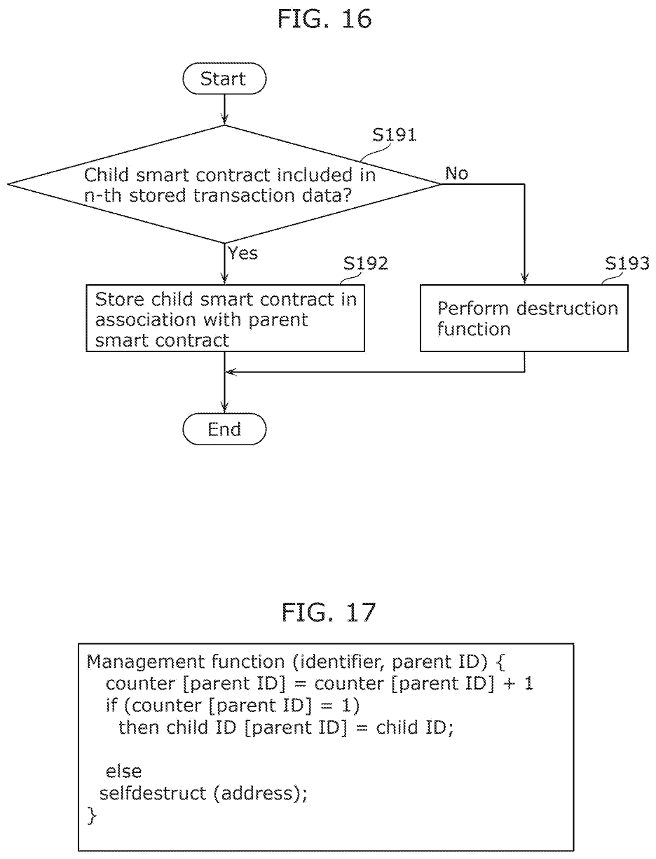

FIG. 16 illustrates the sixth example of the setting process executed by the management function. FIG. 17 illustrates a sixth example of the management function. Although the present embodiment describes that server A performs this process, servers B and C also perform this process.

As illustrated in FIG. 16, server A determines whether, among the plurality of child smart contracts generated based on the same parent smart contract, the smart contract included in n-th transaction data that is stored n-th into distributed ledger 107 is the new smart contract included in the processing-target transaction data (S191). Step S191 is the same as Step S151 and thus the detailed description is omitted.

Next, assume that server A determines that, among the plurality of child smart contracts generated based on the same parent smart contract, the smart contract included in the n-th transaction data stored into distributed ledger 107 is the new smart contract included in the processing-target transaction data (Yes in S191). In this case, server A stores the identifier of this new smart contract in association with the identifier of the parent smart contract (S192). Step S192 is the same as Step S152 and thus the detailed description is omitted.

In contrast to this, assume that server A determines that, among the plurality of child smart contracts generated based on the same parent smart contract, the smart contract included in the n-th transaction data stored into distributed ledger 107 is not the new smart contract included in the processing-target transaction data (No in S191). In this case, server A performs the destruction function on the smart contract included in the transaction data having an ordinal number other than the n-th when stored into distributed ledger 107 (S193). Step S193 is the same as Step S183 and thus the detailed description is omitted.

For example, if n is 2, server A secondly performs the initialization function on new smart contract B stored second into distributed ledger 107 among new smart contracts A, B, and C, as illustrated in FIG. 5. In the setting process of Step S119, the destruction function is performed on new smart contract A. In the setting process of Step S125, new smart contract B is associated with the parent smart contract. In the setting process of Step S131, the destruction function is performed on new smart contract C.

In the sixth example of the setting process, the n-th child smart contract included in the n-th transaction data (where n is a natural number), which is one of the first transaction data and the second transaction data and stored n-th into distributed ledger 107 of server A, is managed as the one child smart contract in association with the parent smart contract. This allows the n-th child smart contract included in the n-th transaction data to be managed as the one child smart contract in association with the parent smart contract.

Moreover, in the sixth example of the setting process, the destruction function, which destructs a smart contract, is performed on the child smart contract included in the transaction data having an ordinal number other than the n-th when stored into distributed ledger 107 of server A. This allows only the n-th generated child smart contract to be associated with the parent smart contract. This also prevents a process of executing the destructed child smart contract and thereby reduces a processing load.

Note that, in Steps S141, S161, and S181, server A may determine whether, among the plurality of child smart contracts generated based on the same parent smart contract, the smart contract on which the management function is firstly performed is the new smart contract included in the processing-target transaction data. More specifically, server A may manage, among the plurality of child smart contracts generated based on the same parent smart contract, the smart contract on which the management function is firstly performed, in association with the parent smart contract.

Note that, in Steps S151, S171, and S191, server A may determine whether, among the plurality of child smart contracts generated based on the same parent smart contract, n-th smart contract on which the management function is performed n-th is the new smart contract included in the processing-target transaction data. More specifically, server A may manage, among the plurality of child smart contracts generated based on the same parent smart contract, the n-th smart contract on which the management function is performed, in association with the parent smart contract.

Note that transaction data A is an example of the first transaction data in server A. Note also that each of transaction data B and transaction data C is an example of the second transaction data in server A.

### Advantageous Effects Etc.

With the management system and so forth according to Embodiment described thus far, the one child smart contract is selected from among the plurality of child smart contracts generated through the execution of the automatic generation function included in the parent smart contracts by the plurality of servers. Then, the one child smart contract selected is managed in association with the parent smart contract. This can prevent redundant storage of the same child smart contracts automatically generated based on the same parent smart contract. Thus, this can also prevent the execution of the same smart contracts by the plurality of devices, and thereby can prevent an inconsistent operation of the management system. As a result, the management system for managing distributed ledgers 107 can operate correctly.

Moreover, with the management system and so forth according to Embodiment, the management function is included in one of the parent smart contract and a management smart contract different from the parent smart contract. The management smart contract is stored m distributed ledger 107. The first transaction data includes execution information used for performing the management function on the first child smart contract. The second transaction data includes execution information used for performing the management function on the second child smart contract. In this case, whenever the first transaction data or the second transaction data is stored into distributed ledger 107, the parent smart contract or the management smart contract can be executed. Thus, whenever the first transaction data or the second transaction data is stored into distributed ledger 107, the management function can be automatically executed.

Furthermore, with the management system and so forth according to Embodiment, the managing includes managing an n-th child smart contract (where n is a natural number) included in n-th transaction data that is one of the first transaction data and the second transaction data and that is stored n-th into the distributed ledger of the one device, as the one child smart contract in association with the parent smart contract. Thus, the n-th generated child smart contract included in the n-th transaction data can be managed as the one child smart contract in association with the parent smart contract.

(Variations)

Although only the exemplary embodiment has been described above, the scope of the Claims of the present application is not limited to the embodiment. The followings are also included in the present disclosure.

(1) Each device in the above-described embodiment is specifically a computer system including, for example, a microprocessor, Read Only Memory (ROM), and Random Access Memory (RAM), a hard disk unit, a display unit, a keyboard, a mouse, and the like. The RAM or the hard disk unit holds a computer program. The microprocessor operates according to the computer program, thereby causing the device to execute its function. Here, the computer program includes combinations of instruction codes for issuing instructions to the computer to execute a predetermined function.

(2) In each device in the above-described embodiment, a part or all of the constituent elements in the device may be implemented into a single Large Scale Integration (LSI), The system LSI is a super multi-function LSI that is a single chip into which a plurality of constituent elements are integrated. More specifically, the system LSI is a computer system including a microprocessor, a ROM, a RAM, and the like. The RAM holds a computer program. The microprocessor operates according to the computer program, thereby causing the system LSI to execute its function.

Each unit in a constituent element included in each device in the above-described embodiment may be integrated separately, or a part or all of them may be integrated into a single chip.

The terminology “system LSI circuit” is used, but depending on the degree of integration, the circuit may also referred to as IC, LSI circuit, super LSI circuit, or ultra LSI circuit. Moreover, the method of circuit integration is not limited to LSI. Integration may be realized with a specialized circuit or a general purpose processor. After the LSI circuit is manufactured, a field programmable gate array (FPGA) or a reconfigurable processor capable of reconfiguring the connections and settings of the circuit cells in the LSI circuit may be used.

Further, if an integrated circuit technology that replaces LSI emerges from advances in or derivations of semiconductor technology, integration of functional blocks using such technology may also be used. Application of biotechnology is also a possibility.

(3) A part or all of the constituent elements included in each device in the above-described embodiment may be implemented into an Integrated Circuit (IC) card or a single module which is attachable to and removable from the device. The IC card or the module is a computer system including a microprocessor, a ROM, a RAM, and the like. The IC card or the module may include the above-described super multi-function LSI. The microprocessor operates according to the computer program to cause the IC card or the module to execute its functions. The IC card or the module may have tamper resistance.

(4) The present disclosure may be the above-above described methods. These methods may be a computer program executed by a computer, or digital signals forming the computer program.

The present disclosure may be a computer-readable recording medium on which the computer program or the digital signals are recorded. Examples of the computer-readable recording medium are a flexible disk, a hard disk, a Compact Disc-Read Only Memory (CD-ROM), a magnetooptic disk (MO), a Digital Versatile Disc (DVD), a DVD-ROM, a DVD-RAM, a BD (Blu-ray(trademark) Disc), and a semiconductor memory. The present disclosure may be the digital signals recorded on the recording medium.

The present disclosure may be implemented by transmitting the computer program or the digital signals via an electric communication line, a wired or wireless communication line, a network represented by the Internet, data broadcasting, and the like.

The present disclosure may be a computer system including a microprocessor and a memory. The memory may store the computer program and the microprocessor may operate according to the computer program.

The program or the digital signals may be recorded onto the recording medium to be transferred, or may be transmitted via a network or the like, so that the program or the digital signals can be executed by a different independent computer system.

(5) The above-described embodiment and the above-described variations may be combined.

### INDUSTRIAL APPLICABILITY

The present disclosure is applicable to a control method, a device, and a recording medium. For example, the present disclosure is applicable to a control method, a device, and a recording medium that are capable of appropriately detecting an unauthorized transaction.

1. A control method that is executed by one device among a plurality of devices included in a management system,
each of the plurality of devices including a distributed ledger that stores: a parent smart contract including an automatic generation function of automatically generating a new smart contract; and a management function of selecting and managing one of a plurality of child smart contracts generated through execution of the automatic generation function by the plurality of devices,
the control method comprising:
generating a first child smart contract through execution of the automatic generation function;
transmitting first transaction data including the first child smart contract generated to a different device among the plurality of devices and storing the first transaction data into the distributed ledger of the one device;
receiving second transaction data including a second child smart contract generated through execution of the automatic generation function by the different device and storing the second transaction data into the distributed ledger of the one device; and
managing one child smart contract that is one of the first child smart contract and the second child smart contract in association with the parent smart contract, through execution of the management function stored in the distributed ledger.

2. The control method according to claim 1,
wherein the management function is included in one of the parent smart contract and a management smart contract different from the parent smart contract,
the management smart contract is stored in the distributed ledger,
the first transaction data includes execution information used for performing the management function on the first child smart contract, and
the second transaction data includes execution information used for performing the management function on the second child smart contract.

3. The control method according to claim 1,
wherein the managing includes managing an n-th child smart contract (where n is a natural number) included in n-th transaction data that is one of the first transaction data and the second transaction data and that is stored n-th into the distributed ledger of the one device, as the one child smart contract in association with the parent smart contract.

4. The control method according to claim 3,
wherein the n is 1.

5. The control method according to claim 3,
wherein the n is a value that is randomly set.

6. The control method according to claim 3,
wherein the managing includes managing an identifier of the n-th child smart contract as an identifier of the one child smart contract so that the n-th child smart contract is managed as the one child smart contract in association with the parent smart contract.

7. The control method according to claim 3,
wherein the managing includes not managing, as the one child smart contract, a child smart contract included in transaction data having an ordinal number other than the n-th when stored into the distributed ledger of the one device.

8. The control method according to claim 3,
wherein the managing includes disabling a child smart contract included in transaction data having an ordinal number other than the n-th when stored into the distributed ledger of the one device.

9. The control method according to claim 3,
wherein the managing includes performing a destruction function, which destructs a smart contract, on a child smart contract included in transaction data having an ordinal number other than the n-th when stored into the distributed ledger of the one device.

10. A device that is one device among a plurality of devices included in a management system and each including a distributed ledger, the one device comprising:
a processor; and
a memory,
wherein the distributed ledger stores: a parent smart contract including an automatic generation function of automatically generating a new smart contract; and a management function of selecting and managing one of a plurality of child smart contracts generated through execution of the automatic generation function by the plurality of devices,
the processor, by using the memory:
generates a first child smart contract through execution of the automatic generation function;
transmits first transaction data including the first child smart contract generated to a different device among the plurality of devices and stores the first transaction data into the distributed ledger of the one device;
receives second transaction data including a second child smart contract generated through execution of the automatic generation function by the different device and stores the second transaction data into the distributed ledger of the one device; and
manages one child smart contract that is one of the first child smart contract and the second child smart contract in association with the parent smart contract, through execution of the management function stored in the distributed ledger.

11. A non-transitory computer-readable recording medium for use in a computer, the recording medium having a computer program recorded thereon for causing the computer to execute a control method to be executed by one device among a plurality of devices included in a management system and each including a distributed ledger that stores:
a parent smart contract including an automatic generation function of automatically generating a new smart contract; and a management function of selecting and managing one of a plurality of child smart contracts generated through execution of the automatic generation function performed by the plurality of devices,
the control method including:
generating a first child smart contract through execution of the automatic generation function;
transmitting first transaction data including the first child smart contract generated to a different device among the plurality of devices and storing the first transaction data into the distributed ledger of the one device;
receiving second transaction data including a second child smart contract generated through execution of the automatic generation function by the different device and storing the second transaction data into the distributed ledger of the one device; and
managing one child smart contract that is one of the first child smart contract and the second child smart contract in association with the parent smart contract, through execution of the management function stored in the distributed ledger.
